(19) United States
(12) Patent Application Publication
(10) Pub. No.: US 2002/0069771 A1
(43) Pub. Date: Jun. 13, 2002

(54) Embossing rollers

(76) Inventor: James A. Pickford, Bredbury (GB)

Correspondence Address: William B. Ritchie, Ritchie Law Offices, 43 Jackson Street, Concord, NH, 03301, US

(21) Appl. No.: 09/859,668

(22) Filed: May 15, 2001

(30) Foreign Application Priority Data
May 17, 2000 (GB) 0011849.7

(51) Int. Cl. B31F 1/07; B44B 5/00

(52) U.S. Cl. 101/6

(57) ABSTRACT

An embossing roller that both embosses and combines sheet materials such as paper or the like. The invention eliminates the need for separate embossing and combining operations. A relief pattern is defined on the surface of the roller such that the relief pattern can be embossed onto multiple ply sheet material by compressing the material against another surface. At least a portion of the raised surface of the roller that defines the relief pattern is provided with projections that combine the multiple plies of the multiple ply material.

### BACKGROUND OF THE INVENTION

1. Field of the Invention

This invention relates to the field of embossing rollers, in particular the invention provides embossing rollers that both emboss and combine sheet materials such as paper or the like.

2. Description of Related Art

Multiple ply embossed paper is used in a number of domestic and industrial fields for a wide range of applications including toilet roll, kitchen roll and paper towelling. It is absorbent, cheap to manufacture and disposable.

Embossing paper allows alteration of its physical and aesthetic properties in a manner best suited to fulfill its intended function. The nature of the pattern to be applied can be selected to enhance its appeal to its intended consumers (for example by application of floral designs) or to increase desired aspects of its performance (for example patterns designed to increase surface area and so improve absorbency).

Combining multiple plies of embossed paper improves the physical properties such as absorbency and also increases the strength of the paper, providing greater resistance to mechanical stresses than if only a single ply is used.

The embossed pattern is normally applied to paper by means of an embossing roller. This roller, onto which the selected design has been applied in raised relief, is used to compress the paper between the embossing roller and a resilient surface, such as another, rubber coated, roller.

If multiple ply embossed paper is to be produced the plies must be combined to prevent their separation from each other. This is conventionally done using combining rollers after the paper has been embossed. Combining rollers have projections known as pins which extend from their surface and which penetrate and combine the plies as the paper is compressed between the combining roller and a resilient surface such as a metal roller or back-plate.

Combining rollers are normally positioned immediately downstream of the embossing apparatus. For effective combination of the plies it is not necessary for the combining to take place across the whole width of the paper, the plies need be combined in only a portion of the paper. To this end it is common for the combining roller to feature only limited fields of pins, which creates bands within which the plies have been combined in the paper which passes through them. These areas of pins are sometimes referred to as knurled bands due to their textured appearance. If the paper is to be out before use into widths less than that of the roll which has been embossed and combined then the combined areas are normally positioned so that they can be aligned with the cutting blades that divide the larger roll. Effective combining can be achieved if each combined area is approximately bisected longitudinally by the blades. This results in production of smaller widths of paper in which a portion of the plies are combined at each longitudinal margin, thereby effectively combining the plies over the total width of the paper.

It is also known to combine plies of embossed paper by the introduction of a suitable adhesive between the plies. The adhesive ensures that the plies will not separate from each other in use. Problems with disposal of such material has, however, led to limited use of this technique.

### SUMMARY OF THE INVENTION

Therefore, it is an aspect of the present invention to provide a new method of combining plies of embossed paper and the like.

This obviates the reliance on the use of separate embossing and combining operations that exists in the prior art. The use of separate combining apparatus imposes, in addition to the financial outlay needed to purchase and maintain the extra apparatus, a requirement for the use of extra space within the production area in which to employ the further machinery. In addition the use of a separate combing step extends the manufacturing time and thereby decreases operational efficiency. The invention allows considerable savings by removing the purchase price, upkeep costs, and increased overheads due to space requirements, of separate combining machinery. It further allows the more efficient production of embossed, multiple ply materials in a single operating process.

The invention provides further advantages over the use of a separate combining roller. Combining the plies by means of a separate combining roller conventionally requires the combining step to take place at a higher pressure than that used for the embossing process, for reasons explained above. This adds an unnecessary complexity to the method of production.

The compressed combined areas produced by separate combining rollers can also detract from the aesthetic, and hence commercial, advantages achieved through the embossing process. The invention allows all combining to take place within the embossed area of the pattern, thereby avoiding the aesthetic deficiencies of the prior art.

The invention is preferable to the use of adhesives to combine the plies. It negates the expense of the adhesives themselves, and, since excess adhesive will often foul both its own application apparatus and also the apparatus of the embossing and cutting steps, decreases the maintenance costs of production. Since no agent other than the material itself is used the properties of the combined and embossed material produced are superior. Use of adhesives frequently alters the material's characteristics, leading to deleterious effects in function, such as decreased degradability of the product.

These aspects of the invention are not meant to be exclusive. Other features, aspects, and advantages of the present invention will be readily apparent to those of ordinary skill in the art when read in conjunction with the following description, appended claims, and accompanying drawings.

### BRIEF DESCRIPTION OF THE DRAWINGS

FIG. 1 illustrates an embossing roller in accordance with the present invention at an intermediate stage of production prior to the formation of combining pins;

FIG. 2 illustrates an engraving roller used to engrave combining pins on to the roller of FIG. 1;

FIG. 3 illustrates the embossing roller of FIG. 1 subsequent to the formation of the combining pins; and

FIG. 4 illustrates examples of alternative cell geometries.

### DETAILED DESCRIPTION OF THE INVENTION

In a preferred embodiment of the invention, substantially the whole surface of the relief pattern is provided with projections able to combine multiple plies of sheet material. This allows material embossed and combined according to the invention to be combined throughout the patterned area. When using combining rollers with pins present only in defined fields it is difficult in practice to ensure that the correct alignment of the cutting blades and bands of combined material occurs, and so effective combining of the plies is sometimes absent if smaller widths are to be produced.

In accordance with a second aspect of the invention there is provided a method of manufacturing an embossing roller according to the first aspect of the invention, the method comprising the steps of:

i) providing a roller with a raised relief pattern; and

ii) providing said raised relief pattern with said projections.

The invention also provides a method of combining multiple plies of sheet material by compression of said material between a roller of the first aspect of the invention and another surface.

Embodiments of the present invention will now be described, by way of example only, with reference to the accompanying drawings, in which:

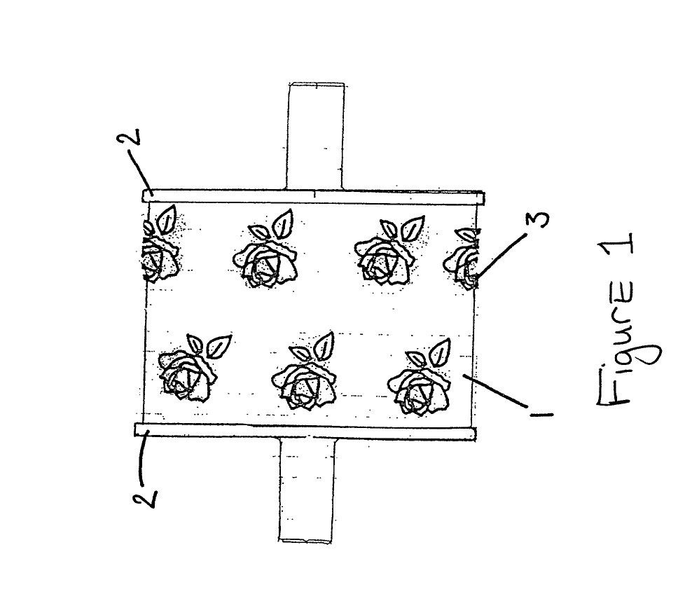

Referring first to FIG. 1, an embossing roller 1 of steel suitable for nitride hardening (such as EN40B) is manufactured to specifications such as length and diameter to suit the embossing/converting machine on which it is intended to be used. It is then ground to a diameter suitable for correct running on the chosen machine. End rings or bands 2 are incorporated at each end of the roller 1. The exact width and height of the bands 2 will be determined by reference to the embossing design 3 that is to be applied to the roller 1.

The chosen design 3 (in this example a floral design) to be embossed is adjusted in size to create a pattern that will form an exact multiple repeat within the circumference of the roller 1. The design 3 is then applied to the roller 1 by conventional emboss engraving techniques of pressure, varnish and acid etching that are well known to those skilled in the art.

The roller 1 is engraved to produce a pattern 3 which is suitably raised above the surface of the roller 1 to perform its embossing function. Calculation of a suitable height will depend on the nature of the design 3, and other factors such as the material and number of plies to be embossed. Calculation of preferable height values will be known to those skilled in the art.

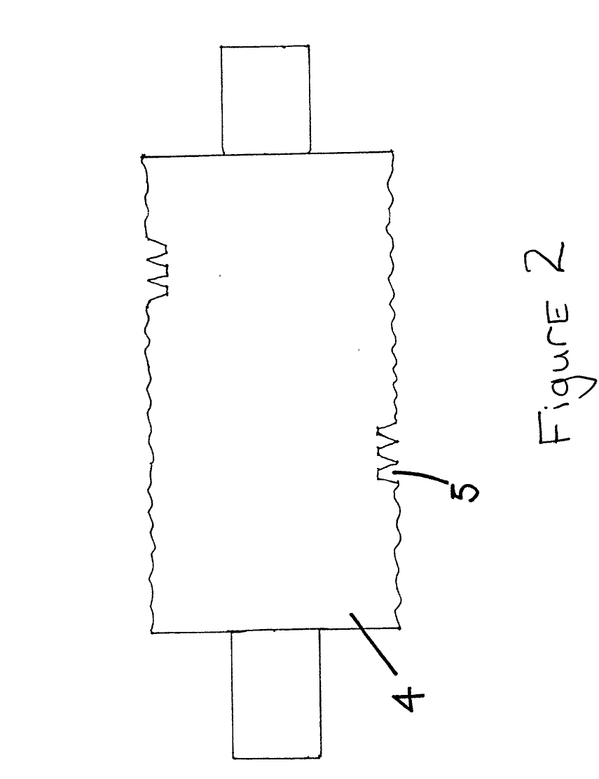

Referring now to FIG. 2, this illustrates an engraving roller 4 used to engrave combining pins onto the embossing roller 1 in accordance with the present invention.

The engraving roller 4 is itself engraved by conventional means in a cell 5 pattern which will define the shape of the combining pins to be formed on the embossing roller. The second roller 4 is now hardened to around 60 Rockwell.

The embossing and engraving rollers 1 and 4 are placed in an engraving machine with a hydraulic or cantilever mill head suitable to accommodate them. The two rollers 1 and 4 are placed in contact under light pressure, so that the end bands 2 of the first roller 1 are in contact with the second roller 4. Any necessary adjustments, such as post-grinding of the raised portion of the design 3 or end bands 2 to ensure the size suitability of the two rollers I and 4, may be made at this point.

The two rollers 1 and 4 are then rotated in contact with each other until a reverse image of the cell pattern 5 appears on the raised portions of the design 3 and the end rings 2. Gradually increasing the pressure allows the operator to ensure. correct alignment of the cell pattern 5 and the design 3. Once correct alignment of the two patterns has been determined acid resistant varnish is introduced to the upper surface 7 of the design 3. Since the rollers 1 and 4 are still in contact under pressure the varnish is displaced from all areas of the upper surface 7 except those in contact with the cell 5 pattern. Acid etching of the emboss roller 1 is then performed to produce a pin 6 that is raised relative to the upper surface 7 of the design 3. Since applying severe pressure may cause distortion of the pins 6 formed it is necessary to gradually increase the pressure between the two rollers 1 and 4, and repeat the acid etching process, until the full required height of the pins 6 is achieved. The required pin 6 height will depend upon the nature of the material to be combined, the number of plies to be combined, the frequency of the pins 6 and the upper surface area 8 of the pins 6. For the combination of two plies of tissue paper using approximately 14 pins 6 per linear cm a pin 6 height of 0.4 mm will ensure effective combining.

As the pin pattern 6 is also be produced upon the upper surface of the end bands 2 the alignment of these pins 6 and the cell pattern 5 of the second roller 4, signifying parallel contact between the two rollers 1 and 4, can be ensured. This allows even formation of the pins 6 on the upper surface 7 of the emboss roller design 3.

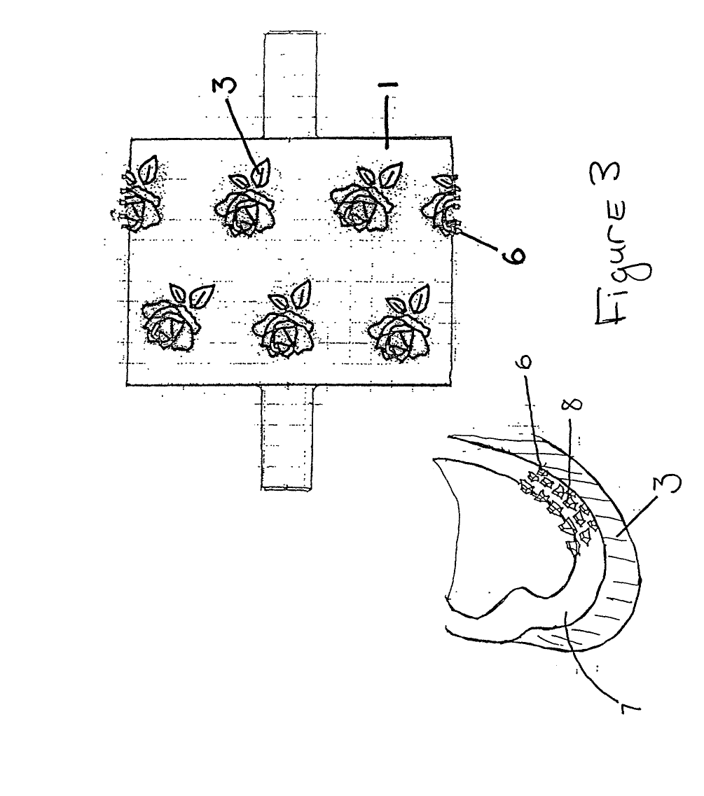

Once the pins 6 have reached the requisite height for their intended use the end bands 2 are ground down to the same height as the surface of the emboss roller 1 as illustrated in FIG. 3. The emboss roller 1 can now be nitride hardened and/or chrome plated before use.

In use the combined embossing/combining roller 1 is run under pressure against a plain backing roller of rubber, or a similar resilient material. The design 3 is thereby embossed into the plies of tissue whilst the pins 6 simultaneously penetrate and combine the plies of the material.

Whilst the above embodiment of the invention utilizes an embossing roller specifically designed for use in the present invention a conventional embossing roller may be provided with combining pins in accordance with the present invention.

For instance removable end bands or rings may be affixed to the ends of an existing engraved embossing roller. The height of the end bands should be greater than the height of the raised relief design. The end bands and the upper surface of the design are post-ground to ensure that they are parallel.

Once the parallel relationship between the end bands and the upper surface of the design has been ensured combining pins may be added to the upper surface of the design by a second etching process as described above. Once pins of the requisite height and shape have been produced the end bands are removed and the emboss roller can now be nitride hardened and/or chrome plated before use.

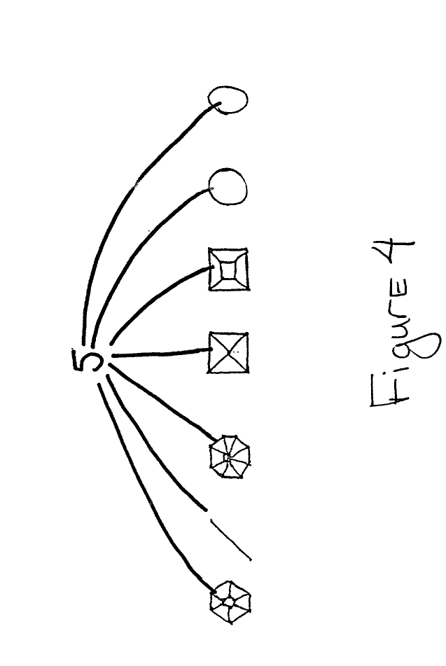

FIG. 4 illustrates a number of different cell geometries 5 that may be used to produce combining pins 6 of different configurations. The cells illustrated would produce (from left to right) hexagonal, straight line, octagonal, pyramidal, truncated pyramidal, round and oval pins 6.

There are many other modifications that may be made to the present invention. For instance it will be appreciated that a relief design of any pattern may be employed.

It will also be appreciated that the shape of the combining pins that may be used is not limited to those that can be produced by the cells illustrated in FIG. 4.

The invention may be used to emboss and combine materials other than paper, or materials in which the plies are of different materials.

The embossing rollers of the invention may be produced from materials other than steel, or from different types of steel to that used in the example.

It will be appreciated that the combining, pins may be provided by a method other than the method exemplified.

The distribution of pins may not be even over the surface of the relief pattern, certain areas of the pattern, or certain motifs within the pattern may not be provided with pins, or may be provided with pins at a greater density than the average.

The frequency of pins may be altered in response to relevant properties of the material that is to be embossed and combined.

It will be appreciated that the height of the relief design may be varied to achieve the most effective embossing and combining of the chosen material.

The illustrated embodiments of the invention are intended to be illustrative only, recognizing that persons having ordinary skill in the art may construct different forms of the invention that fully fall within the scope of the subject matter appearing in the following claims.

What is claimed is:

1. An embossing roller having a relief pattern defined on its surface for embossing said pattern onto multiple ply sheet material by compressing said material against another surface, wherein at least a portion of the raised surface of the roller defining said relief pattern is provided with projections adapted in use to combine the multiple plies of said multiple ply material.

2. An embossing roller according to claim 1, wherein substantially the whole surface of the relief pattern is provided with said projections.

3. An embossing roller according to any of the preceding claims wherein the average height of the projections are less than 1 mm above said raised surface.

4. An embossing roller according to claim 3 wherein the, average height of the projections are less than 0.5 mm in height above said raised surface.

5. An embossing roller according to any preceding claim wherein the average height of the projections are between 0.3 mm and 0.4 mm above said raised surface.

6. An embossing roller according to any preceding claim wherein the average width of the projections is between 0.5 mm and 1 mm.

7. An embossing roller according to any preceding claim wherein the projections are present at a density of between 100 projection per sq cm and 400 projections per sq cm.

8. A method of manufacturing an embossing roller according to any previous claim, the method comprising the steps of:
ii) providing a roller with a raised relief pattern; and
iii) providing said raised relief pattern with said projections.

9. The method of claim 8 wherein the raised relief pattern is provided by an etching process.

10. The method of claim 8 wherein the projections are provided by etching process.

11. A method of combining multiple plies of sheet material by compression of said material between a roller of claim 1 and another surface.

12. The method of claim 9 wherein the projections are provided by etching process.
